(19) United States
(12) Patent Application Publication
(10) Pub. No.: US 2025/0385460 A1
(43) Pub. Date: Dec. 18, 2025

(54) Connector

(71) Applicant: TE Connectivity Solutions GmbH, Schaffhausen (CH)

(72) Inventors: Kevin McKee, Fremont, CA (US); Rohan Narang, Winston Salem, NC (US); David Procter, Middletown, PA (US)

(73) Assignee: TE Connectivity Solutions GmbH, Schaffhausen (CH)

(21) Appl. No.: 18/746,168

(22) Filed: Jun. 18, 2024

(51) Int. Cl. H01R 13/424

(52) U.S. Cl. CPC H01R 13/424

(57) ABSTRACT

A connector includes a common housing and a first assembly received in an assembly receiving passageway of the common housing. The first assembly has a first housing and a first terminal positioned in a first terminal receiving passageway of the first housing. The first housing has a first primary lock formed from a part of an outer surface of the first housing. The first primary lock has a free end that is deflectable with respect to the first housing and engages the first terminal in the terminal receiving passageway. The common housing limits deflection of the first primary lock when the first assembly is disposed in the assembly receiving passageway.

### FIELD OF THE INVENTION

The present invention relates to a connector and, more particularly, to a connector having an assembly received in a common housing.

### BACKGROUND OF THE INVENTION

Connectors are often include housings and terminals positioned in the housings; the housings are mated to electrically connect the terminals, which electrically connects components of an electrical system. Connectors are typically designed for specific applications and, for different numbers and sizes of terminals, require different housing geometries, components, seals, and rear accessories. Typical connector design thus leads to a large number of distinct parts for each product family, which increases complexity and costs while reducing flexibility.

### SUMMARY OF THE INVENTION

A connector includes a common housing and a first assembly received in an assembly receiving passageway of the common housing. The first assembly has a first housing and a first terminal positioned in a first terminal receiving passageway of the first housing. The first housing has a first primary lock formed from a part of an outer surface of the first housing. The first primary lock has a free end that is deflectable with respect to the first housing and engages the first terminal in the terminal receiving passageway. The common housing limits deflection of the first primary lock when the first assembly is disposed in the assembly receiving passageway.

### BRIEF DESCRIPTION OF THE DRAWINGS

The invention will now be described by way of example with reference to the accompanying Figures, of which:

FIG. 1 is a perspective view of a connector according to an embodiment;

FIG. 2 is an exploded perspective view of the connector;

FIG. 3 is a perspective view of a first assembly of the connector;

FIG. 4 is a perspective view of a second assembly of the connector;

FIG. 5A is a perspective view of a secondary lock of the connector;

FIG. 5B is a plan view of the secondary lock in an insertion position;

FIG. 5C is a plan view of the secondary lock in a securing position;

FIG. 6 is a sectional side view of the connector;

FIG. 7 is a schematic diagram of the connector with a plurality of first assemblies and second assemblies;

FIG. 8A is a perspective view of the connector with a pair of backshells;

FIG. 8B is a perspective view of a half of one of the backshells on the first assembly;

FIG. 8C is a perspective view of the half of one of the backshells on the first assembly of another embodiment; and

FIG. 9 is a perspective view of a common housing of the connector according to another embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “longitudinal direction”, “height direction,” and “width direction”. These descriptors are merely for clarity of the description and for differentiation of the various directions. These directional descriptors do not imply or require any particular orientation of the disclosed elements.

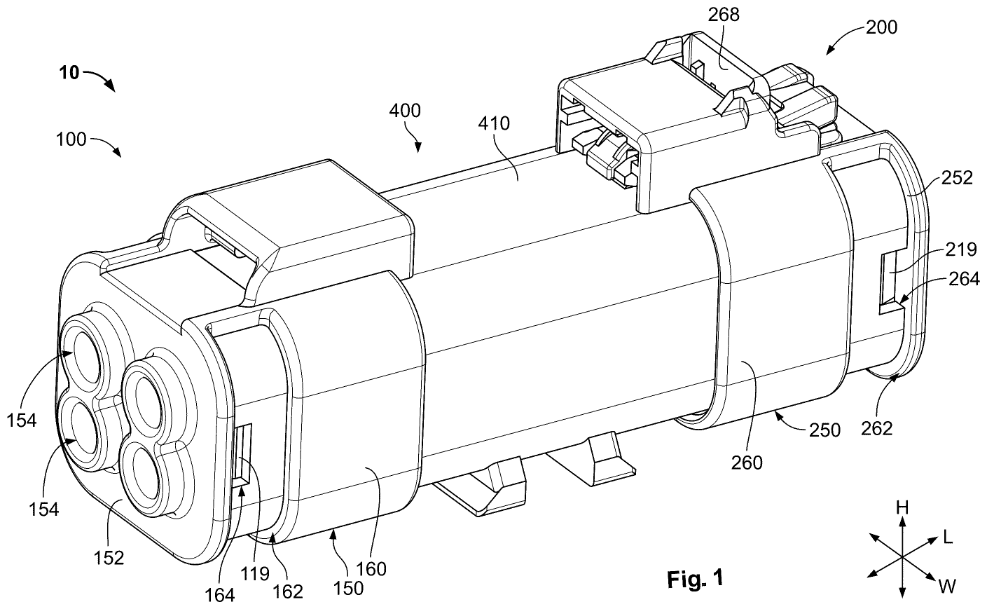

A connector 10 according to an embodiment is shown in FIG. 1. The connector 10 includes a first assembly 100, a second assembly 200, a plurality of interchangeable components 300 that are used with the first assembly 100 and the second assembly 200, and a common housing 400. The first assembly 100 and the second assembly 200 are mateable with one another in the common housing 400.

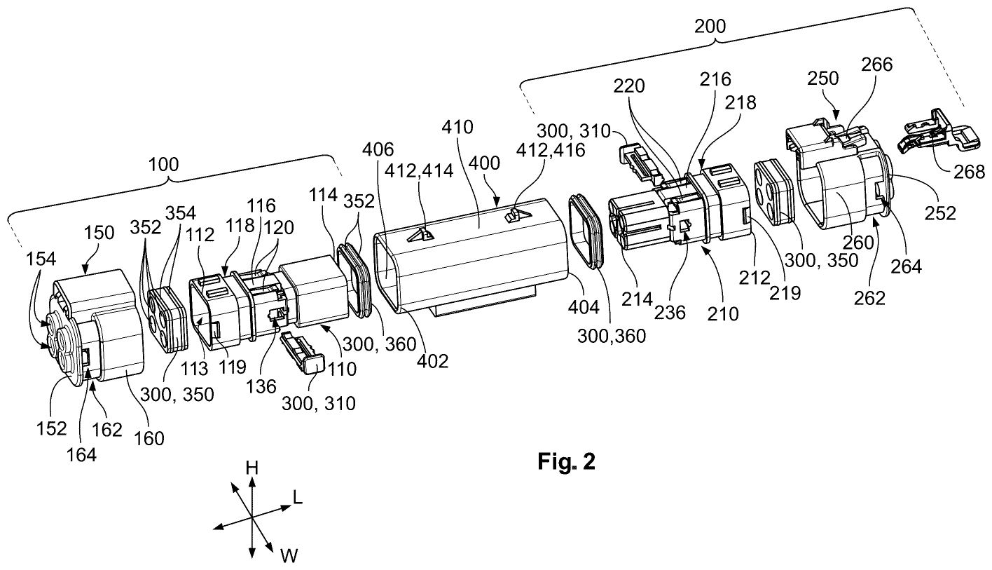

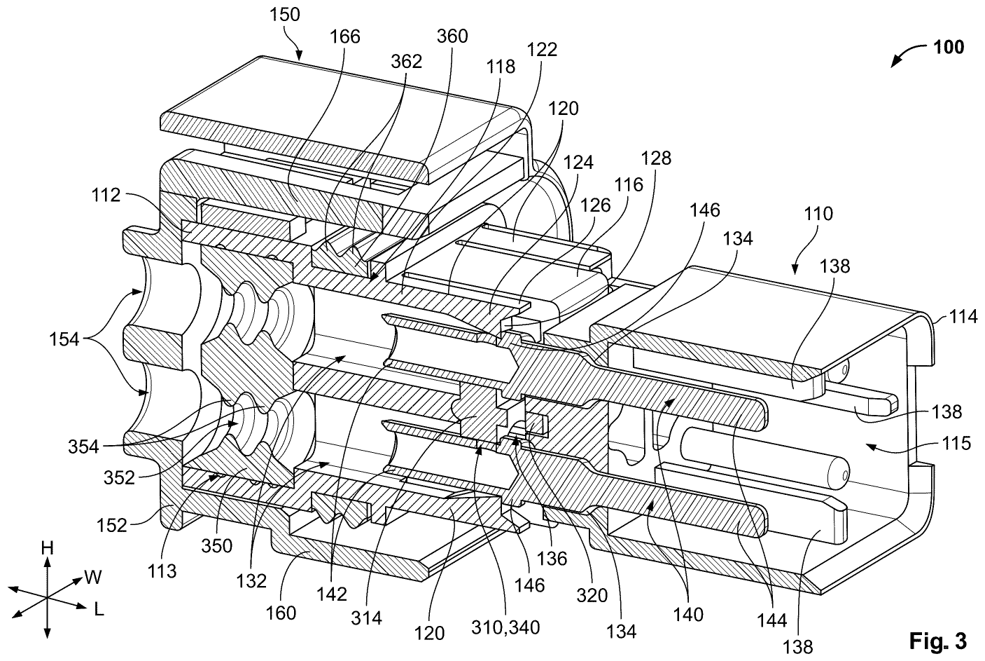

The first assembly 100, as shown in FIGS. 2 and 3, includes a first housing 110, a plurality of first terminals 140 positioned in the first housing 110, and a first cap 150 positioned over an end of the first housing 110.

The first housing 110, as shown in FIGS. 2 and 3, extends between a cap end 112 and a mating end 114 opposite the cap end 112 along a longitudinal direction L. The first housing 110 has a sealing cavity 113 extending into the cap end 112 and a mating cavity 115 extending into the mating end 114. The first housing 110 has an outer surface 116. A sealing groove 118 extends into the outer surface 116 and around the first housing 110 between the cap end 112 and the mating end 114. At the cap end 112, the first housing 110 has a pair of first catches 119 on opposite sides of the first housing 110 and extending from the outer surface 116 in a width direction W perpendicular to the longitudinal direction L.

As shown in FIGS. 2 and 3, the first housing 110 has a plurality of first primary locks 120 each formed from a part of the outer surface 116 of the first housing 110. The first primary locks 120, as shown in FIG. 3, each extend from a fixed end 122 to a free end 124 along the longitudinal direction L. At the free end 124, each of the first primary locks 120 has a lip 126 extending along the longitudinal direction L and a stop surface 128 extending along a height direction H perpendicular to the longitudinal direction L and the width direction W.

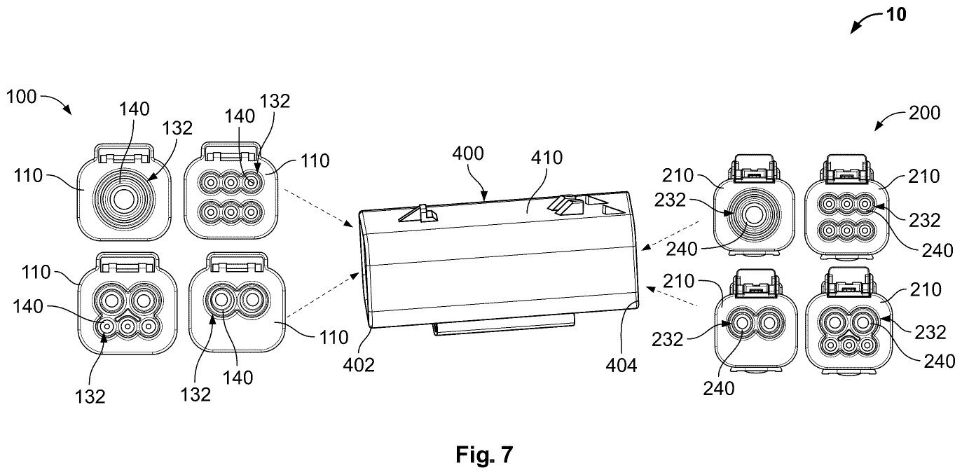

The first housing 110, as shown in FIG. 3, has a plurality of first terminal receiving passageways 132 extending through the first housing 110 between the sealing cavity 113 and the mating cavity 115 along the longitudinal direction L. At an end of each of the first terminal receiving passageways 132, the first housing 110 has a locating feature 134. One of the first primary locks 120 is positioned in correspondence with each of the first terminal receiving passageways 132, with the stop surface 128 of the first primary lock 120 extending into the corresponding first terminal receiving passageway 132. In the shown embodiment, the first housing 110 has four first terminal receiving passageways 132 and four first primary locks 120. In other embodiments, as described in greater detail below with reference to FIG. 7, the first housing 110 may have less than four or more than four first terminal receiving passageways 132 and corresponding first primary locks 120.

As shown in FIG. 2, the first housing 110 has a first locking passageway 136 extending into the first housing 110 in the width direction W. As shown in FIG. 3, the first locking passageway 136 is positioned between the first terminal receiving passageways 132 and at least partially overlaps each of the first terminal receiving passageways 132.

In the mating cavity 115 at the mating end 114, the first housing 110 has a plurality of first alignment features 138. The first alignment features 138 extend along the longitudinal direction L and protrude into the mating cavity 115. In the shown embodiment, the first housing 110 has four alignment features 138 in the mating cavity 115. In other embodiments, the first housing 110 may have less than four or more than four alignment features 138.

In the shown embodiment, the first housing 110, including the first primary locks 120, the locating features 134 of the first terminal receiving passageways 132, and the first alignment features 138, is monolithically formed in a single piece from an insulative material, such as a plastic. The first primary locks 120 are part of the outer surface 116 of the first housing 110 and are connected only at the fixed end 122. The first primary locks 120 are deflectable with respect to the first housing 110 about the fixed end 122 to move the free end 124, and the stop surface 128 of the free end 124, into and out of the corresponding first terminal receiving passageway 132

As shown in FIG. 3, the first assembly 100 includes a plurality of first terminals 140 positioned in the first housing 110. The first terminals 140 are round terminals and each extend from a connecting end 142 to a mating end 144 along the longitudinal direction L. In the shown embodiment, the first terminals 140 are each formed as a pin at the mating end 144. The first terminals 140 each have a shoulder 146 extending circumferentially around the first terminal 140 between the connecting end 142 and the mating end 144. In the shown embodiment, the first terminals 140 are each monolithically formed in a single piece from a conductive material, such as copper or aluminum. In another embodiment, the first terminals 140 described herein can be formed from a plurality of pieces assembled together.

The first assembly 100 includes a first cap 150, as shown in FIGS. 1-3. The first cap 150 has a first cover wall 152 and a first shroud 160 extending from the first cover wall 152 along the longitudinal direction L. The first cover wall 152 is positioned in a plane defined by the height direction H and the width direction W and has a plurality of first cap passageways 154 extending through the first cover wall 152 along the longitudinal direction L. The number of first cap passageways 154 corresponds to the number of first terminal receiving passageways 132 of the first housing 110.

As shown in FIGS. 1 and 2, the first shroud 160 has a first shroud groove 162 extending around a portion of the first shroud 160. The first shroud 160 has a plurality of first recesses 164 positioned in the first shroud groove 162 that extend through the first shroud 160. The first cap 150, as shown in FIG. 3, has a first latching arm 166 extending from the first cover wall 152 and positioned within the first shroud 160. The first latching arm 166 is deflectable with respect to the first cap 150.

In the shown embodiment, the first cap 150, including the first cover wall 152, the first shroud 160, and the first latching arm 166, is monolithically formed in a single piece from an insulative material, such as a plastic.

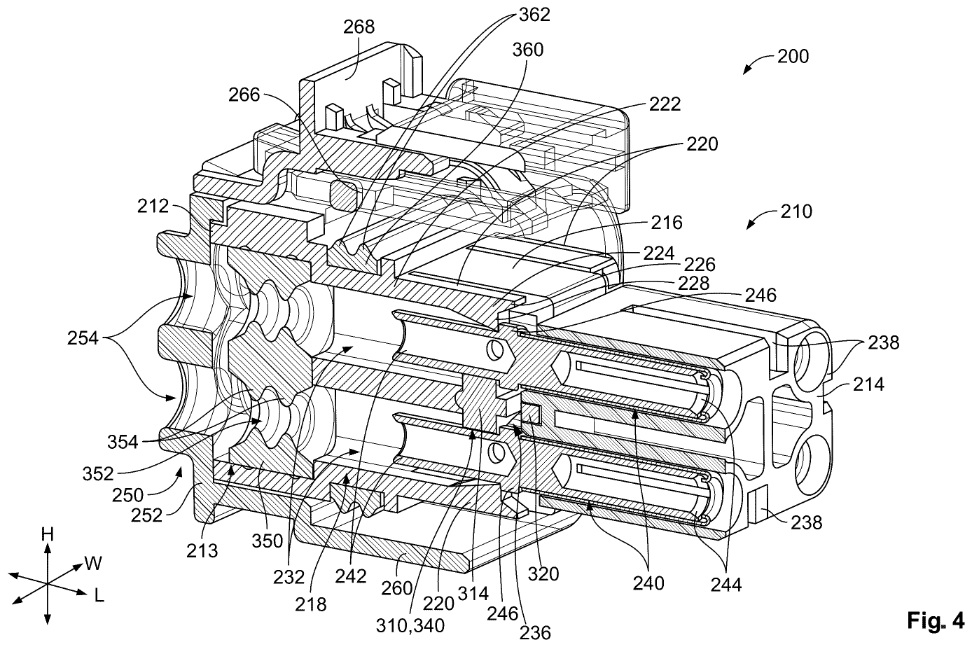

The second assembly 200, as shown in FIGS. 2 and 4, includes a second housing 210, a plurality of second terminals 240 positioned in the second housing 210, and a second cap 250 positioned over an end of the second housing 210.

The second housing 210, as shown in FIGS. 2 and 4, extends between a cap end 212 and a mating end 214 opposite the cap end 212 along the longitudinal direction L. The second housing 210 has a sealing cavity 213 extending into the cap end 212. The second housing 210 has an outer surface 216. A sealing groove 218 extends into the outer surface 216 and around the second housing 210 between the cap end 212 and the mating end 214. At the cap end 212, the second housing 210 has a pair of second catches 219 on opposite sides of the second housing 210 and extending from the outer surface 216 in the width direction W.

As shown in FIGS. 2 and 4, the second housing 210 has a plurality of second primary locks 220 each formed from a part of the outer surface 216 of the second housing 210. The second primary locks 220, as shown in FIG. 4, each extend from a fixed end 222 to a free end 224 along the longitudinal direction L. At the free end 224, each of the second primary locks 220 has a lip 226 extending along the longitudinal direction L and a stop surface 228 extending along the height direction H.

The second housing 210, as shown in FIG. 4, has a plurality of second terminal receiving passageways 232 extending through the second housing 210 between the sealing cavity 213 and the mating end 214 along the longitudinal direction L. One of the second primary locks 220 is positioned in correspondence with each of the second terminal receiving passageways 232, with the stop surface 228 of the second primary lock 220 extending into the corresponding second terminal receiving passageway 232. In the shown embodiment, the second housing 210 has four second terminal receiving passageways 232 and four second primary locks 220. In other embodiments, as described in greater detail below with reference to FIG. 7, the second housing 210 may have less than four or more than four second terminal receiving passageways 232 and corresponding second primary locks 220.

As shown in FIG. 4, the second housing 210 has a second locking passageway 236 extending into the second housing 210 in the width direction W. As shown in FIG. 4, the second locking passageway 236 is positioned between the second terminal receiving passageways 232 and at least partially overlaps each of the second terminal receiving passageways 232.

At the mating end 214, the second housing 210 has a plurality of second alignment features 238. The second alignment features 238 are grooves extending along the longitudinal direction L into the outer surface 216 of the second housing 210. In the shown embodiment, the second housing 210 has four second alignment features 238. In other embodiments, the second housing 210 may have less than four or more than four second alignment features 238, provided that the number of second alignment features 238 corresponds to the number of first alignment features 138.

In the shown embodiment, the second housing 210, including the second primary locks 220 and the second alignment features 238, is monolithically formed in a single piece from an insulative material, such as a plastic. The second primary locks 220 are part of the outer surface 216 of the second housing 210 and are connected only at the fixed end 222. The second primary locks 220 are deflectable with respect to the second housing 210 about the fixed end 222 to move the free end 224, and the stop surface 228 of the free end 224, into and out of the corresponding second terminal receiving passageway 232.

As shown in FIGS. 2-4, the first housing 110 and the second housing 210 are formed similarly and have similar components. The sealing cavities 113, 213 are formed at the cap end 112, 212 similarly in the first housing 110 and the second housing 210, the sealing grooves 118, 218 are formed similarly on the outer surfaces 116, 216, and the first primary locks 120 are formed identically to the second primary locks 220.

As shown in FIG. 4, the second assembly 200 includes a plurality of second terminals 240 positioned in the second housing 210. The second terminals 240 are round terminals and each extend from a connecting end 242 to a mating end 244 along the longitudinal direction L. In the shown embodiment, the second terminals 240 are each formed as a socket at the mating end 244. The second terminals 240 each have a shoulder 246 extending circumferentially around the second terminal 240 between the connecting end 242 and the mating end 244. In the shown embodiment, the second terminals 240 are each monolithically formed in a single piece from a conductive material, such as copper or aluminum. In another embodiment, the second terminals 240 described herein can be formed from a plurality of pieces assembled together.

The second assembly 200 includes a second cap 250, as shown in FIGS. 1, 2, and 4. The second cap 250 has a second cover wall 252 and a second shroud 260 extending from the second cover wall 252 along the longitudinal direction L. The second cover wall 252 is positioned in a plane defined by the height direction H and the width direction W and has a plurality of second cap passageways 254 extending through the second cover wall 252 along the longitudinal direction L. The number of second cap passageways 254 corresponds to the number of second terminal receiving passageways 232 of the second housing 210.

As shown in FIGS. 1 and 2, the second shroud 260 has a second shroud groove 262 extending around a portion of the second shroud 260. The second shroud 260 has a plurality of second recesses 264 positioned in the second shroud groove 262 that extend through the second shroud 260. The second cap 250, as shown in FIG. 4, has a second latching arm 266 extending from the second cover wall 252 and positioned within the second shroud 260. The second cap 250 is shown outlined and partially transparent in FIG. 4 for ease of the depiction of other details in the drawing. The second latching arm 266 is deflectable with respect to the second cap 250. The second cap 250 has a connector position assurance (CPA) device 268 that can be inserted into the second shroud 260 to limit deflection of the second latching arm 266.

In the shown embodiment, the second cap 250, including the second cover wall 252, the second shroud 260, and the second latching arm 266, is monolithically formed in a single piece from an insulative material, such as a plastic. As shown in FIGS. 2-4, the second cap 250 and the first cap 150 are formed similarly and have similar components including the cover walls 152, 252, the shrouds 160, 260, and the latching arms 166, 266 within the shrouds 160, 260.

The interchangeable components 300, as shown in FIG. 2, include a secondary lock 310, an inner seal 350, and an outer seal 360 that are interchangeably positionable in the first housing 110 and the second housing 210.

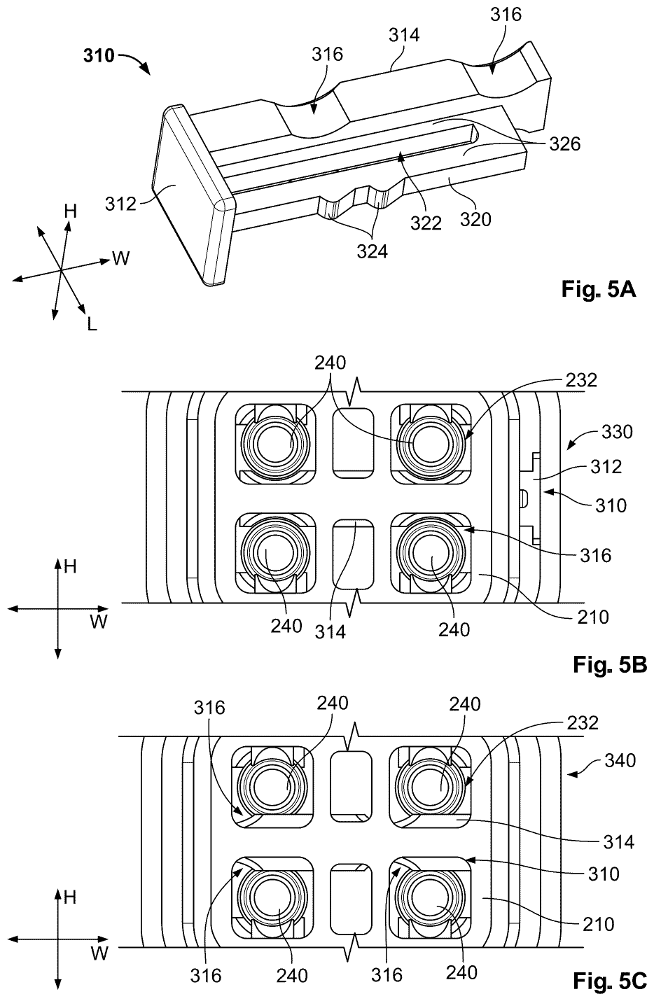

The secondary lock 310, as shown in FIG. 5A, has a base 312, a securing arm 314 extending from the base 312, and a deflectable arm 320 extending from the base 312. The securing arm 314 and the deflectable arm 320 extend from the base 312 in the width direction W and are approximately parallel and spaced apart from one another in the longitudinal direction L. The securing arm 314 has a plurality of recesses 316 extending into the securing arm 314. In the shown embodiment, each of the recesses 316 has a semicircular shape. In other embodiments, each of the recesses 316 could have any shape, provided the shape corresponds to the shape of a portion of the terminals 140, 240. The deflectable arm 320 has a deflection opening 322 extending through the deflectable arm 320 that allows a pair of legs 326 of the deflectable arm 320 to be resiliently deflected toward each other. As shown in FIG. 5A, one of the legs 326 has a plurality of protrusions 324 extending from the leg 326. In the shown embodiment, the secondary lock 310 is monolithically formed in a single piece from an insulative material.

The inner seal 350, as shown in FIGS. 2-4, has a plurality of sealing passageways 352 extending through the inner seal 350. At each of the sealing passageways 352, the inner seal 350 has a plurality of inner ribs 354 extending into the sealing passageway 352. The inner seal 350 is monolithically formed in a single piece from an elastomeric material.

The outer seal 360, as shown in FIGS. 2-4, has a plurality of outer ribs 362 extending outward from the outer seal 360. The outer seal 360 is monolithically formed in a single piece from an elastomeric material.

The common housing 400, as shown in FIGS. 1, 2, and 6, extends from a first end 402 to a second end 404 along the longitudinal direction L. The common housing 400 has an inner surface 406 and an outer surface 410 opposite the inner surface 406. An assembly receiving passageway 408 of the common housing 400 is defined by the inner surface 406 and extends between the first end 402 and the second end 404. On the outer surface 410, the common housing 400 has a pair of catches 412 that protrude from the outer surface 410. The catches 412 include a first catch 414 positioned adjacent to the first end 402 and a second catch 416 positioned adjacent to the second end 404. In the shown embodiment, the common housing 400 is monolithically formed in a single piece from an insulative material.

The assembly of the first assembly 100 and the second assembly 200 will now be described in greater detail. As will be described in detail below, the interchangeable components 300 can be used in either the first assembly 100 or the second assembly 200.

For the first assembly 100, as shown in FIG. 3, the inner seal 350 is positioned in the sealing cavity 113 of the first housing 110 and the outer seal 360 is positioned in the sealing groove 118 on the outer surface 116 of the first housing 110. The inner seal 350 resiliently abuts against the first housing 110 in the sealing cavity 113 and each of the sealing passageways 352 of the inner seal 350 is aligned with one of the first terminal receiving passageways 132 along the longitudinal direction L.

The second assembly 200 accommodates the inner seal 350 and the outer seal 360 formed identically to the inner seal 350 and the outer seal 360 of the first housing 110 as described above. In the second assembly 200, as shown in FIG. 4, the inner seal 350 is positioned in the sealing cavity 213 of the second housing 210 and the outer seal 360 is positioned in the sealing groove 218 on the outer surface 216 of the second housing 210. The inner seal 350 resiliently abuts against the second housing 210 in the sealing cavity 213 and each of the sealing passageways 352 of the inner seal 350 is aligned with one of the second terminal receiving passageways 232 along the longitudinal direction L. The inner seal 350 and the outer seal 360 are components that are interchangeably positionable in either the first assembly 100 or the second assembly 200.

As shown in FIG. 3, in the first assembly 100, the first terminals 140 are each inserted into one of the first terminal receiving passageways 132 of the first housing 110 through one of the sealing passageways 352 of the inner seal 350. The connecting ends 142 of each of the first terminals 140 may be connected, for example crimped, to a cable, and the inner ribs 354 may resiliently abut the cable after insertion to seal to the cable. As the first terminal 140 is inserted along the longitudinal direction L, the shoulder 146 abuts the first primary lock 120 that extends into the first terminal receiving passageway 132 and resiliently deflects the first primary lock 120 outwards.

When the first terminal 140 reaches the position shown in FIG. 3 during insertion along the longitudinal direction L, the first primary lock 120 resiliently returns to retain the first terminal 140 in the first terminal receiving passageway 132. In this position, the stop surface 128 at the free end 124 of the first primary lock 120 engages the shoulder 146 to prevent movement of the first terminal 140 along the longitudinal direction L. A portion of the first terminal 140 abuts the locating feature 134 in this position, with the locating feature 134 positioning and aligning the first terminal 140 within the first terminal receiving passageway 132.

As shown in FIG. 4, in the second assembly 200, the second terminals 240 are each inserted into one of the second terminal receiving passageways 232 of the second housing 210 through one of the sealing passageways 352 of the inner seal 350. The connecting ends 242 of each of the second terminals 240 may be connected, for example crimped, to a cable, and the inner ribs 354 may resiliently abut the cable after insertion to seal to the cable. As the second terminal 240 is inserted along the longitudinal direction L, the shoulder 246 abuts the second primary lock 220 that extends into the second terminal receiving passageway 232 and resiliently deflects the second primary lock 220 outwards.

When the second terminal 240 reaches the position shown in FIG. 4 during insertion along the longitudinal direction L, the second primary lock 220 resiliently returns to retain the second terminal 240 in the second terminal receiving passageway 232. In this position, the stop surface 228 at the free end 224 of the second primary lock 220 engages the shoulder 246 to prevent movement of the second terminal 240 along the longitudinal direction L.

In the position of the primary locks 120, 220 shown in FIGS. 3 and 4, the primary locks 120, 220 formed from the outer surfaces 116, 216 of the housings 110, 210 permit simple removal of the terminals 140, 240; a tool can be inserted under the lip 126, 226 and used to deflect the primary lock 120, 220 outward, releasing the securing of the terminal 140, 240.

The secondary lock 310, which provides secondary locking for the first terminals 140 and the second terminals 240, is identical and interchangeable in the first assembly 100 and the second assembly 200. The secondary lock 310 is movable from the insertion position 330 to a securing position 340 in both the first housing 110 and the second housing 210 in the same manner described in detail below. Although FIGS. 5B and 5C show the movement of the secondary lock 310 with respect the second housing 210 and the second terminals 240, the same movement and engagement applies to the secondary lock 310 of the first housing 110 that provides secondary locking for the first terminals 140.

The first terminals 140 are inserted in the first terminal receiving passageways 132 to the position secured by the first primary locks 120, shown in FIG. 3, and the second terminals 240 are inserted in the second terminal receiving passageway 232 to the position secured by the second primary locks 220, shown in FIG. 4, with the secondary lock 310 in the insertion position 330 respectively in each of the first housing 110 and the second housing 210. In the insertion position 330, shown in FIG. 5B, each of the recesses 316 is aligned with one of the first terminal receiving passageways 132 or the second terminal receiving passageways 232. The alignment of the recesses 316 with the terminal receiving passageways 132, 232 avoids obstructing the insertion of the terminals 140, 240.

With the terminals 140, 240 fully inserted, the secondary lock 310 is moved in the locking passageway 136, 236 of the first housing 110 and the second housing 210 from the insertion position 330 to the securing position 340, shown in FIG. 5C. The secondary lock 310 is moved from the insertion position 330 to the securing position 340 in the width direction W, which is a direction perpendicular to the first terminal receiving passageways 132 and the second terminal receiving passageways 232. In the securing position 340, as shown in FIG. 5C, the securing arm 314 overlaps with the first terminal receiving passageways 132 or the second terminal receiving passageways 232. As shown in FIGS. 3 and 4, in the securing position 340, the securing arm 314 abuts the shoulder 146, 246 of the first terminal 140 or the second terminal 240 to provide additional locking of the terminal 140, 240 along the longitudinal direction L that supplements the locking of the primary locks 120, 220, securing the terminals 140, 240 in the respective receiving passageways 132, 232.

The deflectable arm 320 of the secondary lock 310 retains the secondary lock 310 in the first housing 110 or the second housing 210 in both the insertion position 330 and the securing position 340. One of the protrusions 324 of the deflectable arm 320 engages the first housing 110 of the second housing 210 in each of the insertion position 330 and the securing position 340; the deflection of the deflectable arm 320 allows the secondary lock 310 to be secured to the first housing 110 or the second housing 210 in each of these positions 330, 340 and moved between the positions 330, 340 along the width direction W.

In the first assembly 100, the first cap 150 is positioned over the cap end 112 of the first housing 110, as shown in FIG. 3. The first cover wall 152 of the first cap 150 abuts the cap end 112 and each of the first cap passageways 154 is aligned with one of the sealing passageways 352 of the inner seal 350 and one of the first terminal receiving passageways 132 of the first housing 110. As shown in FIG. 1, the first catches 119 each engage in one of the first recesses 164 of the first cap 150 to secure the first cap 150 to the cap end 112.

The second cap 250 is assembled to the second housing 210 in a manner similar to the first cap 150 on the first housing 110. In the second assembly 200, the second cap 250 is positioned over the cap end 212 of the second housing 210, as shown in FIG. 4. The second cover wall 252 of the second cap 250 abuts the cap end 212 and each of the second cap passageways 254 is aligned with one of the sealing passageways 352 of the inner seal 350 and one of the second terminal receiving passageways 232 of the second housing 210. As shown in FIG. 1, the second catches 219 each engage in one of the second recesses 264 of the second cap 250 to secure the second cap 250 to the cap end 212.

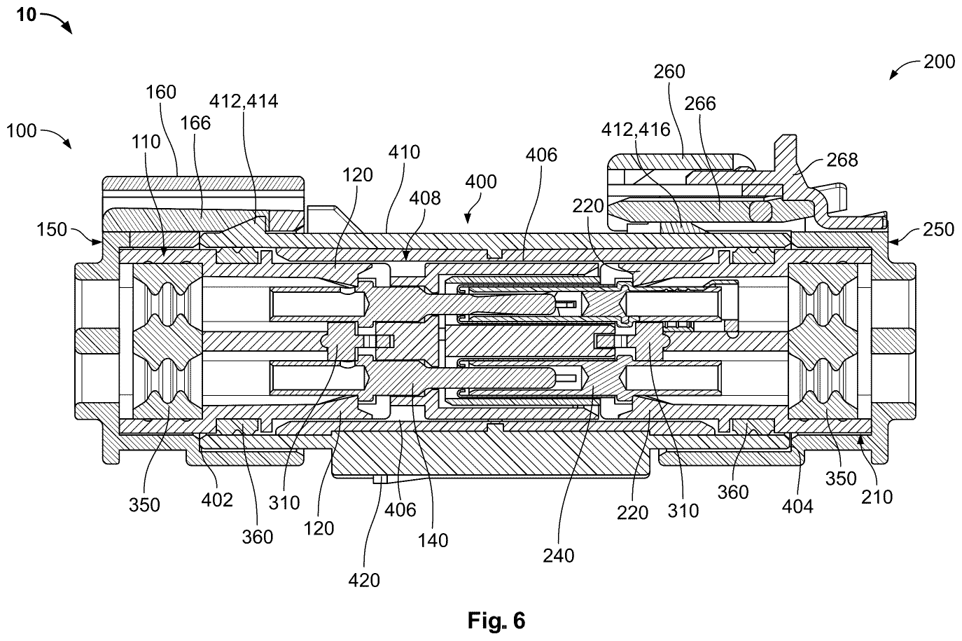

With the first assembly 100 and the second assembly 200 assembled as described above and as shown in FIGS. 3 and 4, the first assembly 100 and the second assembly 200 are inserted into the common housing 400 to form the connector 10, as shown in FIGS. 1 and 6. The first assembly 100 is inserted into the assembly receiving passageway 408 at the first end 402 of the common housing 400 and the second assembly 200 is inserted into the assembly receiving passageway 408 at the second end 404 of the common housing 400. As the first assembly 100 and the second assembly 200 are inserted to a mated position, the first alignment features 138 of the first housing 110 each interact with one of the second alignment features 238 of the second housing 210 to align the first assembly 100 with respect to the second assembly 200.

When the first assembly 100 and the second assembly 200 are fully inserted and received in the assembly receiving passageway 408 of the common housing 400, as shown in FIG. 6, the first assembly 100 and the second assembly 200 are mated in the assembly receiving passageway 408. The first terminals 140 are mated and electrically connected with the second terminals 240 in this position. The inner surface 406 of the common housing 400 is positioned adjacent to the first primary locks 120 of the first housing 110 and the second primary locks 220 of the second housing 210 in the mated position, limiting deflection of the primary locks 120, 220 and further securing the terminals 140, 240 when the first assembly 100 and the second assembly are mated in the assembly receiving passageway 408.

In the mated position shown in FIG. 6, the outer seal 360 on each of the first housing 110 and the second housing 210 abuts the inner surface 406 of the common housing 400 to seal the first assembly 100 and the second assembly 200 with respect to the assembly receiving passageway 408.

To secure the first assembly 100 and the second assembly 200 in the mated position shown in FIG. 6, the caps 150, 250 engage and secure to the common housing 400. The first latching arm 166 of the first cap 150 deflects over and releasably engages with the first catch 414 of the common housing 400 to secure the first assembly 100 in the assembly receiving passageway 408. The second latching arm 266 of the second cap 250 deflects over and releasably engages with the second catch 416 of the common housing 400 to secure the second assembly in the assembly receiving passageway 408. As shown in FIG. 6, the CPA device 268 can be inserted into the second shroud 260 to limit deflection of the second latching arm 266 and prevent unintentional disconnection of the second latching arm 266 from the second catch 416. In another embodiment, a CPA device can alternatively or additionally be positioned in the first shroud 160 to limit deflection of the first latching arm 166.

In the embodiment shown in FIG. 6, the common housing 400 has a mounting feature 420 on the outer surface 410. The mounting feature 420 allows the common housing 400, and the connector 10 including the common housing 400, to be attached to a mounting device.

Alternatively, the first assembly 100 and the second assembly 200 can be mated in the assembly receiving passageway 408 of the common housing 400 by inserting the first assembly 100 into the second end 404 and the second assembly 200 into the first end 402. The mating of the terminals 140, 240, securing of the primary locks 120, 220 with the inner surface 406 of the common housing 400, and connections of the caps 150, 250 to the common housing 400 function the same independent of which ends 402, 404 of the common housing 400 the assemblies 100, 200 are inserted into.

FIG. 7 illustrates that the connector 10 of the above-described embodiments is flexible and, with the same common housing 400, can accommodate a number of different connection arrangements of the first assembly 100 and the second assembly 200. As shown in the illustrative example of FIG. 7, the first assembly 100 may be any one of a plurality of different first assemblies 100 that have a first housing 110 with a same outer dimension and are interchangeably positionable in the common housing 400 and differ in at least one of a size of the first terminal 140 and a number of first terminal receiving passageways 132 that have the first terminals 140. The second assembly 200 also can be any one of a plurality of different second assemblies 200 that have a second housing 210 with a same outer dimension and are interchangeably positionable in the common housing 400 and differ in at least one of a size of the second terminal 240 and a number of second terminal receiving passageways 232 that have the second terminal 240. The number and size of the first terminals 140 in the selected first assembly 100 correspond to the number and size of the second terminals 240 of the selected second assembly 200 that mates with the first assembly 100 in the assembly receiving passageway 408 of the common housing 400.

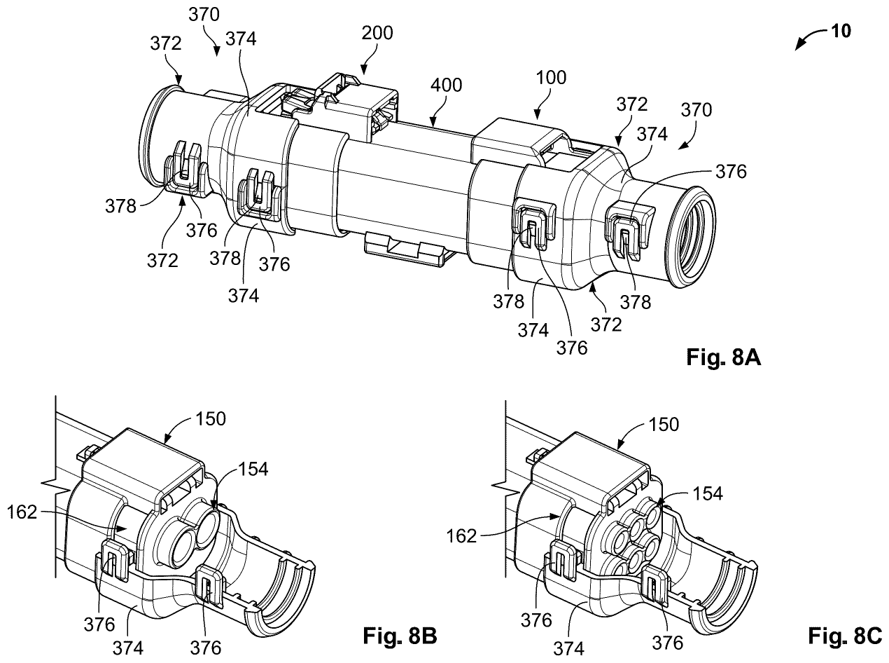

As shown in FIGS. 8A-8C, in another embodiment, the interchangeable components 300 can include a backshell 370 that is positionable on the first assembly 100 or the second assembly 200. As shown in FIG. 8A, the backshell 370 includes a pair of halves 372 that are identical to one another. Each of the halves 372 includes a backshell body 374 that has a plurality of backshell latches 376 on one side and a plurality of backshell catches 378 on an opposite side.

As shown in FIGS. 8A-8C, the backshell 370 can be removably connected to the first cap 150 of the first assembly 100 or the second cap 250 of the second assembly 200. The backshell body 374 of one of the halves 372 of the backshell 370 is positioned in the shroud groove 162, 262 of the cap 150, 260 and the other of the halves 372 is moved into the shroud groove 162, 262 to connect with the first half 372. The backshell latches 376 of one of the halves 372 connect with the backshell catches 378 of the other of the halves 372 to secure the backshell 370 to the assembly 100, 200. The backshell 370 can be used to partially cover and secure the cable connected to the terminals 140, 240. As shown in FIGS. 8B and 8C, the backshell 370 can be interchangeably used with assemblies 100, 200 having different numbers and different sizes of terminals 140, 240 that correspond to the number and size of the cap passageways 154, 254 in the caps 150, 250.

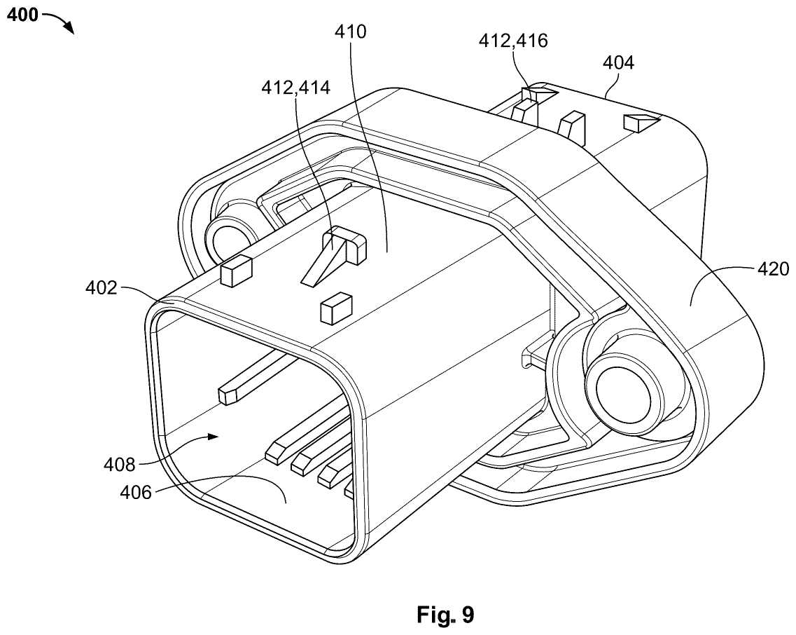

The common housing 400 that interchangeably receives the first assembly 100 and the second assembly 200 is not limited to the particular embodiment described above. In another embodiment, as shown in FIG. 9, the common housing 400 can connect the first assembly 100 and the second assembly 200 that are positioned on opposite sides of a panel. In this embodiment, the common housing 400 is a panel mount and has a panel flange 420 that protrudes from the outer surface 410 and is mountable to a panel. In another embodiment, the common housing 400 can be a header for a printed circuit board. In further embodiments, the common housing 400 can have a plurality of assembly receiving passageways 408 for the mating of multiple first assemblies 100 and second assemblies 200, which may differ in the size and number of terminals 140, 240.

In the embodiments of the connector 10 described above, the common center housing 400 can be used to connect a variety of first assemblies 100 and second assemblies 200 without requiring a change in geometry. The interchangeable components 300 are usable with all variations of terminal 140, 240 sizes and arrangements of the first assembly 100 and the second assembly 200, which further increases flexibility and decreases the need to create unique components for each arrangement. The common features of the housings 110, 210, such as the primary locks 120, 220, simplify the tooling used to produce the connector 10 and further decrease the costs of production. The connector 10 provides a flexible and modular solution that permits the connection of a variety of assemblies 100, 200 having a variety of terminals 140, 240 at decreased cost and complexity.

What is claimed is:

1. A connector, comprising:
a common housing; and
a first assembly received in an assembly receiving passageway of the common housing, the first assembly has a first housing and a first terminal positioned in a first terminal receiving passageway of the first housing, the first housing has a first primary lock formed from a part of an outer surface of the first housing, the first primary lock has a free end that is deflectable with respect to the first housing and engages the first terminal in the terminal receiving passageway, the common housing limits deflection of the first primary lock when the first assembly is disposed in the assembly receiving passageway.

2. The connector of claim 1, further comprising a second assembly received in the assembly receiving passageway of the common housing and mateable with the first assembly in the assembly receiving passageway.

3. The connector of claim 2, wherein the second assembly has a second housing and a second terminal positioned in a second terminal receiving passageway of the second housing, the second housing has a second primary lock formed from a part of an outer surface of the second housing, the second primary lock has a free end that is deflectable with respect to the second housing and engages the second terminal in the terminal receiving passageway.

4. The connector of claim 3, wherein the common housing limits deflection of the second primary lock when the second assembly is disposed in the assembly receiving passageway.

5. The connector of claim 3, wherein the first terminal is electrically connected with the second terminal when the first assembly and the second assembly are mated within the assembly receiving passageway of the common housing.

6. The connector of claim 3, wherein the first primary lock is formed identically to the second primary lock.

7. The connector of claim 1, wherein the first housing has a locating feature at an end of the first terminal receiving passageway that positions the first terminal within the first terminal receiving passageway, the locating feature is monolithically formed in a single piece with the first housing.

8. The connector of claim 5, wherein the first housing has a first alignment feature and the second housing has a second alignment feature, the first alignment feature and the second alignment feature interact during mating in the assembly receiving passageway to align the first assembly with respect to the second assembly.

9. The connector of claim 3, wherein the first assembly includes a first cap positioned over an end of the first housing, the first cap releasably engages a first catch on the common housing to secure the first assembly in the assembly receiving passageway.

10. The connector of claim 9, wherein the second assembly includes a second cap positioned over an end of the second housing, the second cap releasably engages a second catch on the common housing to secure the second assembly in the assembly receiving passageway.

11. The connector of claim 3, further comprising a plurality of interchangeable components that are interchangeably positionable in the first housing and the second housing.

12. The connector of claim 11, wherein the interchangeable components include a secondary lock that is movable between an insertion position and a securing position in the first housing or the second housing, the secondary lock secures the first terminal in the first terminal receiving passageway or the second terminal in the second terminal receiving passageway in the securing position.

13. The connector of claim 11, wherein the secondary lock is movable between the insertion position and the securing position in a direction perpendicular to the first terminal receiving passageway and the second terminal receiving passageway.

14. The connector of claim 12, wherein the secondary lock has a base, a securing arm extending from the base, and a deflectable arm extending from the base.

15. The connector of claim 14, wherein the securing arm has a recess that is aligned with the first terminal receiving passageway or the second terminal receiving passageway in the insertion position and overlaps with the first terminal receiving passageway or the second terminal receiving passageway in the securing position.

16. The connector of claim 11, wherein the interchangeable components include an inner seal positionable within the first housing and/or the second housing and having a sealing passageway aligned with the first terminal receiving passageway and/or the second terminal receiving passageway.

17. The connector of claim 11, wherein the interchangeable components include an outer seal positioned on the outer surface of the first housing and/or the second housing, the outer seal abuts an inner surface of the common housing when the first housing and/or the second housing is positioned in the assembly receiving passageway.

18. The connector of claim 11, wherein the interchangeable components include a backshell connected to the first assembly and/or the second assembly.

19. The connector of claim 3, wherein the common housing has a first end and a second end with the assembly receiving passageway extending between the first end and the second end, the first assembly is insertable into either of the first end and the second end and the second assembly is insertable into the other of the first end and the second end to mate with the first assembly in the assembly receiving passageway.

20. The connector of claim 1, wherein the first assembly is one of a plurality of first assemblies that are interchangeably positionable in the common housing, the first assemblies differ in at least one of a size of the first terminal and a number of first terminals in the first housing.
